(19) United States
(12) Patent Application Publication
(10) Pub. No.: US 2026/0339648 A1
(43) Pub. Date: Oct. 29, 2026

(54) SYSTEM AND METHOD FOR UPDATING VEHICLE SOFTWARE PROGRAMS USING OVER THE AIR DELIVERY TO A VEHICLE AT A VEHICLE SERVICE CENTER

(71) Applicant: Ford Global Technologies, LLC, Dearborn, MI (US)

(72) Inventors: Tawfik Mohammed, Ottawa (CA); Safeeul Bashir Safee, Canton, MI (US); Eric Marsman, Canton, MI (US); Daniel Joseph Madrid, Grand Rapids, MI (US); Eric Shoff, Harrison Township, MI (US); Ian Taylor, Tampa, FL (US)

(21) Appl. No.: 19/193,007

(22) Filed: Apr. 29, 2025

(51) Int. Cl. G06F 8/65

(52) U.S. Cl. CPC G06F 8/65

(57) ABSTRACT

A system includes a processor and a non-transitory computer readable medium including programming instructions. The programming instructions, when executed by the processor, cause the processor to generate a vehicle software plan to update a vehicle software for a vehicle system from an installed version to a desired version. The vehicle software plan may include any intervening software versions between the installed version and the desired version. The programming instructions, when executed by the processor, further cause the processor to execute a vehicle software update to transmit, via a wireless communication link, one or more software packages to the vehicle system with the vehicle system being in a service mode in accordance with the vehicle software plan in response to the vehicle software plan being accepted, and update the vehicle system from the service mode to a non-service mode in response to the vehicle software being updated to the desired version.

### TECHNICAL FIELD

The present disclosure generally relates to systems and/or methods for updating software programs in a vehicle.

### BACKGROUND

Modern vehicles are increasingly reliant on software to control and manage various electronic systems and components, including but not limited to powertrain control, braking systems, infotainment systems, advanced driver-assistance systems (ADAS), and telematics functions. As a result, vehicles may include numerous software-controlled modules, each potentially requiring periodic software updates to maintain functionality, adjust performance, or address security vulnerabilities.

Software updates for vehicle systems can be performed at authorized service centers or repair facilities. In such settings, a technician connects a computing device, such as a diagnostic scan tool or service computer, to the vehicle via a wired interface (e.g., on-board diagnostics (OBD) port). The computing device is then used to transmit software updates to the control modules of the vehicle.

### SUMMARY

In some aspects, the present disclosure is directed to a system including a processor and a non-transitory computer readable medium comprising programming instructions. The programming instructions, when executed by the processor, cause the processor to generate a vehicle software plan to update a vehicle software for a vehicle system from an installed version to a desired version. The vehicle software plan may include any intervening software versions between the installed version and the desired version. The programming instructions, when executed by the processor, further cause the processor to execute a vehicle software update to transmit, via a wireless communication link, one or more software packages to the vehicle system with the vehicle system being in a service mode in accordance with the vehicle software plan in response to the vehicle software plan being accepted, and update the vehicle system from the service mode to a non-service mode in response to the vehicle software being updated to the desired version.

In another aspect, the present disclosure is directed to a non-transitory computer-readable medium comprising instructions for updating vehicle software in a vehicle system that, when executed by one or more processors perform operations including to: generate a vehicle software plan to update a vehicle software for a vehicle system from an installed version to a desired version, the vehicle software plan including any intervening software versions between the installed version and the desired version; execute a vehicle software update to transmit, via a wireless communication link, one or more software packages to the vehicle system with the vehicle system being in a service mode in accordance with the vehicle software plan in response to the vehicle software plan being accepted; and updating the vehicle system from the service mode to a non-service mode in response to the vehicle software being updated to the desired version.

In yet another aspect, the present disclosure is directed to a method including: generating a vehicle software plan to update a vehicle software for a vehicle system from an installed version to a desired version, the vehicle software plan including any intervening software versions between the installed version and the desired version; executing a vehicle software update to transmit, via a wireless communication link, one or more software packages to the vehicle system with the vehicle system being in a service mode in accordance with the vehicle software plan in response to the vehicle software plan being accepted; and updating the vehicle system from the service mode to a non-service mode in response to the vehicle software being updated to the desired version.

### BRIEF DESCRIPTION OF THE DRAWINGS

FIG. 1 illustrates a vehicle service system and a vehicle support system for over the air software updates to a vehicle in accordance with the present disclosure.

FIG. 2 is a flowchart of an example software update control for the vehicle service system in accordance with the present disclosure.

FIG. 3 is a flowchart of an example software update for the vehicle support system in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Existing methods for performing software updates present certain inefficiencies. For example, software updates are typically delivered to a vehicle module one at a time such that the vehicle module is updated with each released version of the software up to the desired version without prior knowledge of how many versions are required. Each software version update can require a technician to download, install the software, turn the vehicle on and off, and validate the software. This manual and sequential update process can result in prolonged service times and increased labor costs.

The present disclosure is directed toward a system and/or method for updating vehicle software by emulating and automating a vehicle software update to plan a software download sequence for updating a vehicle software. For example, the system may generate a vehicle software plan to update a vehicle software for a vehicle system from an installed version to a desired version. The vehicle software plan may include any intervening software versions between the installed version and the desired version. The system further executes a vehicle software update to transmit, via a wireless communication link, one or more software packages to the vehicle system with the vehicle system being in a service mode in accordance with the vehicle software plan in response to the vehicle software plan being accepted. Once the vehicle software is updated to the desired version, the vehicle system is updated from the service mode to a non-service mode. The system/method of the present disclosure automates and streamlines the update process by, for example, planning the software update sequence, simplifying the operation of the technician, and providing real-time monitoring and cancellability.

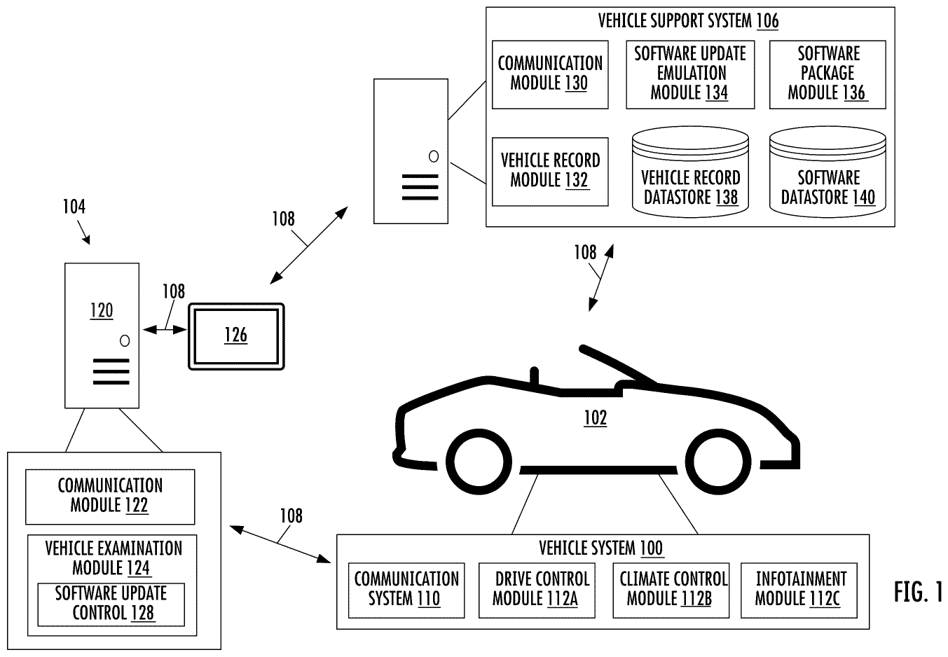

Referring to FIG. 1, a vehicle system 100 provided for a vehicle 102 includes multiple subsystems configured to perform a range of vehicular functions. The subsystems may include, without limitation, systems related to vehicle propulsion, environmental or climate control (e.g., heating and cooling functionalities), battery management for electric vehicles, and infotainment or entertainment functionalities. Each subsystem may include one or more hardware components (e.g., electric motor, internal combustion engine, braking mechanisms, battery assemblies, audio output devices, sensors, and the like) and may additionally include a computing device having one or more software components executable by one or more processors. The software components (e.g., vehicle software) are configured to control or facilitate the operation of the respective subsystems, such as, for example, controlling motor speed, managing passenger cabin temperature, or controlling charging and discharging cycles of the vehicle battery system.

The vehicle software associated with the vehicle subsystems may be updated post-manufacture to, for example, modify or enhance functionality of the respective subsystems. As detailed herein, the software updates may be performed at vehicle service centers (e.g., dealership and/or service garage) having a vehicle service system 104 that is in communication with a vehicle support system 106 storing one or more versions of the vehicle software. While the vehicle service system 104 and vehicle support system 106 are described as being located at different locations with different servers, the system 104 and 106 may be provided at the same location and may be realized with one or more common servers.

In the figures arrows 108 illustrate wireless communication links between different systems and/or components.

In some aspects, the vehicle system 100 includes a communication system 110 that operates as a central communication hub between external systems (e.g., vehicle service system 104 and vehicle support system 106) and modules in the vehicle system 100, and even between modules within the vehicle system 100. For example, the communication system 110 receives software updates from the vehicle support system 106 and distributes the software update to an intended module of the vehicle system 100. Among other components, the communication system 110 may include a gateway controller configured to establish communication between the various modules of the vehicle system 100 and a telematics control unit (TCU) configured to establish wireless and wired communication with external devices (e.g., the vehicle service system 104 and the vehicle support system 106).

In a non-limiting example, the other modules of the vehicle system 100 may include: a drive control module 112A to control propulsion of the vehicle 102; a climate control module 112B to control temperature of a passenger cabin; and an infotainment module 112C to control an infotainment system of the vehicle 102. The modules 112A, 112B, and 112C may collectively be referred to as vehicle modules 112. Among other components, the system 110 and the vehicle modules 112 may include hardware devices like processors and memory storing software programs executable by the processor.

The vehicle service system 104 at a vehicle service center is configured to perform diagnostics on the vehicle 102 including determining whether vehicle software installed in the vehicle 102 should be updated. In some implementations, the vehicle service system 104 includes a server 120 that defines a communication module 122 and a vehicle examination module 124. The server 120 may also include a datastore storing records of various vehicles that have undergone service at the service center. A technician at the vehicle service center may access information and diagnostic tools of the vehicle service system 104 through a computing device 126 (e.g., a tablet, a laptop, a smartphone, and/or other suitable computing device) that is in communication with the server 120 via, for example, a dedicated software application installed on the computing device 126 and/or a web-based interface.

The communication module 122 is configured to exchange information with various external systems using various communication methods, such as, but not limited to, wired communication and wireless communication (e.g., Wi-Fi, cellular network, and/or BLUETOOTH). For example, the communication module 122 is configured to communicate with the vehicle support system 106 to exchange information related to, for example, the vehicle 102 being serviced. The communication module 122 may also exchange information with the computing device 126 to communicate with the vehicle 102. That is, the computing device 126 may include a communication circuit/interface that establishes wired/wireless communication with the vehicle 102. Accordingly, the communication module 122 may include devices such as modem, router, antenna, and/or microprocessor for establishing communication with external systems/devices using various communication protocols.

The vehicle examination module 124 is configured to execute one or more diagnostics on the vehicle 102, such as, but not limited to checking whether the vehicle system 100 flagged one or more diagnostic trouble codes, performing an emission test, and/or performing a battery discharge-charge test. The vehicle examination module 124 also determines whether new versions of the vehicle software installed in the vehicle system 100 are available using a software update control 128.

More particularly, with the computing device 126 in communication with the vehicle 102, the software update control 128 obtains a unique vehicle identification associated with the vehicle 102 (e.g., a vehicle identification number) and in some implementation, information related to the vehicle software installed in the vehicle 102 (e.g., name of vehicle software, version, and/or installation date). The software update control 128 is configured to place the vehicle 102 in a service mode during which selected controls are inactivated (e.g. selected controls include no propulsion, engine is off, and/or battery pack is not discharging or charging) and may only receive over the air communications that are specifically transmitted during service mode (e.g., communication is limited with only the vehicle service system 104 and the vehicle support system 106). In a non-limiting example, the software update control 128 places the vehicle 102 in the service mode by transmitting a message instructing the vehicle system 100 to enter service mode via the computing device 126. The communication system 110 of the vehicle 102 distributes the message requesting the service mode to the vehicle modules 112. In some aspects, the vehicle 102 may exit the service mode upon instructions from the vehicle examination module 124 and/or when the vehicle 102 is turned-on.

With the vehicle 102 in the service mode, the software update control 128 is configured to request the vehicle support system 106 to provide a vehicle software plan for the vehicle 102 based on, at least, the unique vehicle identification. If one or more vehicle software should be updated to a newer version, the vehicle support system 106 generates the vehicle software plan and provides the plan to the vehicle service system 104 for approval. That is, once received, software update control 128 displays a message to the technician on the computing device 126 providing details of the software plan including an estimated time of installation and requests either approval or cancellation of the software update. If approved, the software update control 128 notifies the vehicle support system 106, which begins over the air software update of the vehicle system 100. The software update control 128 continues to notify the technician of any updates from the vehicle support system 106 including completion of the software update and/or issues regarding updates. In some variations, the software update control 128 may automatically approve the vehicle software plan in response to the vehicle software plan satisfying one or more factors (e.g., a software update time is equal to or less than a selected time period or a date associated with the desired version is past a selected time period). In some aspects, the software update control 128 is configured to allow that technician to select among the software updates for the vehicle modules 112. For example, the updates for a selected module 112 may be selected while updates for unselected modules 112 may be postponed.

In some aspects, the vehicle support system 104 is configured to perform over the air software updates on the vehicle 102 based on a vehicle software plan designed for the vehicle 102. The vehicle support system 104 may be provided as a remote server that is configured to communicate with external devices/systems (e.g., vehicle system 100 and the vehicle service system 104). In certain embodiments, the vehicle support system 106 may be operated, maintained, or otherwise supported by the original equipment manufacturer (OEM) of the vehicle 102. The vehicle support system 104 may include a communication module 130, a vehicle record module 132, a software update emulation module 134, and a software package module 136.

The communication module 130 is configured to exchange information with various external systems using one or more communication techniques, such as, but not limited to, wired communication and wireless communication (e.g., Wi-Fi, cellular network, and/or BLUETOOTH). Accordingly, the communication module 130 may include devices such as, but not limited to, modem, router, antenna, and/or microprocessor for establishing communication with external systems/devices using various communication protocols.

The vehicle record module 132 is configured to manage and store vehicle information related to vehicles registered with the vehicle support system 106 (e.g., the vehicle 102). In non-limiting example, the vehicle information may include vehicle make and model; part numbers of hardware/software components of the vehicle; diagnostic history; service history, and/or information related to vehicle software installed in the vehicle (e.g., program name, version currently installed, and/or date of last update. The vehicle information may be stored as a vehicle record in a vehicle record datastore 138 using the unique vehicle identification as a way to associate a respective vehicle record with the vehicle 102.

The software update emulation module 134 is configured to generate a vehicle software plan to update vehicle software from the version currently installed in the vehicle 102 (e.g., an installed version) to a desired version, which may be latest version. In some implementations, the desired version may be identified in the vehicle record when a software version release for a vehicle software is issued, set by the OEM, or is the latest version of the vehicle software. In some implementations, the software update emulation module 134 retrieves the vehicle record for the vehicle 102 from the record datastore 138 based on the unique vehicle identification and determines whether the vehicle software in the vehicle system 100 should be updated based on the installed version and the desired version. In some aspects, the vehicle software update emulation module 134 looks at each vehicle software of the vehicle system 100 to determine which vehicle software is to be updated.

To generate the vehicle software plan, the software update emulation module 134 simulates vehicle software update for each vehicle software to be updated. Specifically, for a given vehicle module 112 of the vehicle system 100, the software update emulation module 134 sequentially and iteratively retrieves, from a software datastore 140, a software file for the vehicle software starting with the version issued immediately after the installed version, then the next issued version, until the desired version. The software datastore 140 is configured as a software library storing a plurality of software files for different vehicle software used by the vehicle modules 112, where a selected vehicle software is associated with multiple software files that are different versions of the vehicle software.

The sequential retrieval is done for each vehicle software to be updated in the vehicle system 100, where along with the desired version, the vehicle software plan may include any intervening software version between the installed version and the desired version. Accordingly, the vehicle software plan provides a simulated sequence of how the vehicle software changes, step-by-step for the vehicle system 100. In some aspects, the vehicle software plan identifies the vehicle modules 112 to be updated, part numbers associated with the vehicle software that may change due to the software update, and the configuration updates that may be applied.

The software update emulation module 134 is further configured to determine a software update time for the vehicle software plan, where the software update time is an estimation of how long the vehicle software update will take. In a non-limiting example, the software update time is estimated using metadata of update artifacts (e.g., software file(s)) which includes data around flashing times in the vehicle system 100. The size of the artifact and estimated ranges of download speeds are used to estimate possible download durations/times. The sum of the flashing time and the download time is then offered as a total estimate to the technician.

Once defined, the software update emulation module 134 is configured to transmit a software update message including information indicative of the vehicle software plan to the vehicle service system. In a non-limiting example, the software update message provides details of the vehicle software plan, including software update time, download size of the software files, and the vehicle modules 112 that are to be updated.

In some aspects, the software update process may be cancelled at any time by, for example, having the technician request cancellation via an interface associated with the software update process or the vehicle 102 exiting the service mode, which may be detected directly by the vehicle support system 106 and/or the vehicle service system 104 notifying the vehicle support system 106. In addition, the software update message further requests approval of the vehicle software plan (e.g., activation of the software update) or cancellation of the vehicle software plan (e.g., deactivation of the software update). In a non-limiting example, the technician may approve or cancel the software update defined by the vehicle software plan via the computing device 126.

The software package module 136 is configured to initiate the software update of one or more vehicle software in response to the vehicle software plan being accepted. In a non-limiting example, for each vehicle module 112 to be updated, the software package module 136 obtains a first software file of the first version provided in the vehicle software plan and transmits all the first software files as a software package to the vehicle system 100 via wireless communication. The software files having different versions are provided one at a times (e.g., iteratively and in-sequence) per the vehicle software plan.

Once received, the vehicle system 100 distributes the software file(s) to respective vehicle modules 112. That is, the software package include information identifying which vehicle modules 112 is to receive the software files provided in the software package. Once download is complete, the vehicle system 100 notifies the vehicle support system 104 to receive the next software file(s) for the vehicle modules 112 per the vehicle software plan. Accordingly, the vehicle system 100 updates the vehicle software incrementally until the desired version is obtained.

During the update, the vehicle system 100 may transmit status to the vehicle support system 106, which may further notify the vehicle service system 104 including the computing device 126 managed by the technician. Once the vehicle software is updated, the vehicle support system 106 requests the vehicle service system 104 to have the vehicle 102 exit service mode and be placed in a regular operation mode allowing operation of all vehicle controls. If an issue arises during the update, the vehicle software update may be suspended and the vehicle service system 104 may investigate the issue.

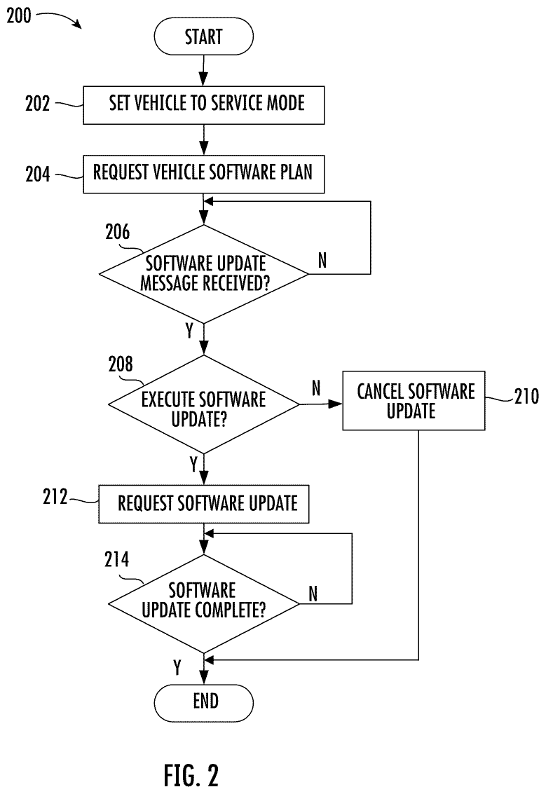

Referring to FIG. 2, an example software update control routine 200 performed by the vehicle service system 104 is described in association with the above description. The routine 200 is performed for the vehicle 102 that is being serviced at the vehicle service center.

At operation 202, the vehicle service system 104 places the vehicle 102 in a service mode to inactivate selected controls. In a non-limiting example, the vehicle service system 104 transmits a message or command requesting control in the service mode to the vehicle system 100 via a wireless communication link.

At operation 204, the vehicle service system 104 requests the vehicle support system 106 to generate a vehicle software plan for the vehicle 102. In a non-limiting example, the request may include, for example, the unique vehicle identification, make/model of the vehicle 102, and/or part numbers associated with the module 112, among other information. The technician may transmit the request by operating a computing device 126 associated with the vehicle support system 104.

At operation 206, the vehicle service system 104 is configured to determine if a software update message is received from the vehicle support system 106. In a non-limiting example, the vehicle service system 104 may wait for the software update message for a selected time period before cancelling the request and notifying the technician to request the vehicle software plan again or perform other action (e.g., check communication connection).

If the software update message is received, the vehicle service system 104, at operation 208, determines whether the software update is to be executed. In a non-limiting example, the software update message is displayed to the technician with an acceptance and cancellation buttons allowing the technician to review the vehicle software plan and supporting information such as the software update time. In another example, the vehicle service system 104 may be configured to automatically accept the vehicle software plan in response to the vehicle software plan satisfying one or more factors (e.g., the software update time is equal to or less than a selected time period or a date associated with the desired version is past a selected time period).

If the vehicle software plan is declined/cancelled, the vehicle service system 104 notifies the vehicle support system 106, at operation 210.

If the vehicle software plan is accepted, the vehicle service system 104 requests the software update from the vehicle support system 106, at operation 212 by transmitting a message to the vehicle support system 106.

At operation 214, the vehicle service system 104 determines if the software update is complete based on a notification from at least one of the vehicle system 100 and/or the vehicle support system 106. If complete, the routine 200 ends.

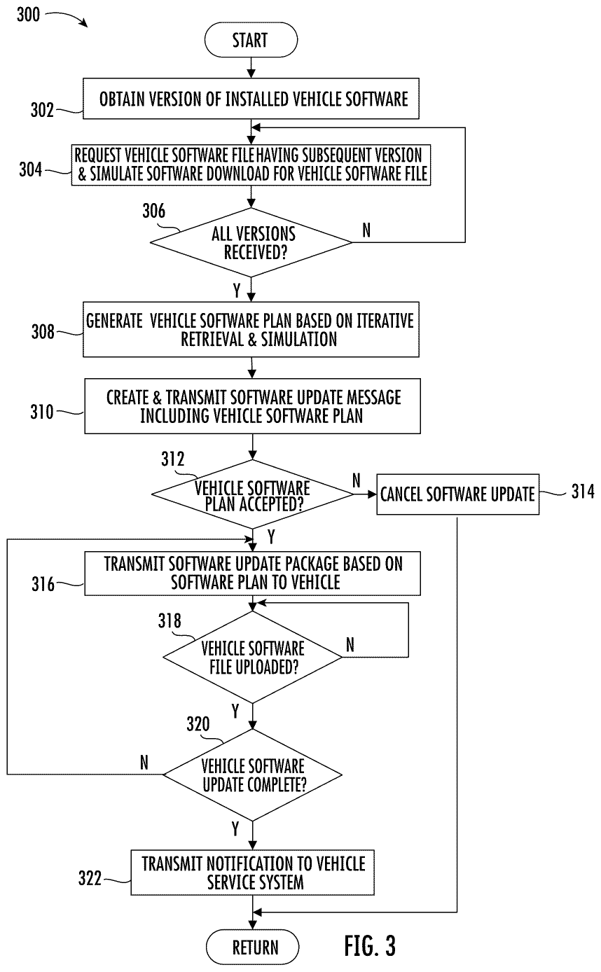

FIG. 3 is a flowchart of an example software update routine 300 for the vehicle support system 106 in accordance with the present disclosure. In some aspects, the software update routine 300 begins when a vehicle software plan is requested from the vehicle support system 104. It will be appreciated that the vehicle support system 106 may be configured to support a plurality of vehicle support systems 104, and accordingly, may execute the routine 300 with respect to each of the supported vehicle support systems 104.

At operation 302, the vehicle support system 106 obtains the installed versions of the vehicle software provided in the vehicle module 112. In non-limiting example, the install versions may be provided with the vehicle software plan request and/or provided in a vehicle record associated with the vehicle 102. In some aspects, the installed version of all vehicle software employed by the vehicle system 100 and managed by the vehicle service system 106 is obtained. Alternatively, vehicle software associated with one or more selected vehicle modules 112 is evaluated.

At operation 304, the vehicle support system 106 is configured to generate the vehicle software plan to update the vehicle software from the installed version to the desired version. In a non-limiting example, for each vehicle software, the vehicle support system 106 requests a software file for the version issued after the installed version and simulate a download of the software file requested.

At operation 306, the vehicle support system 106 determines if all versions are retrieved. In a non-limiting example, the vehicle support system 106 compares version recently retrieved with the desired version. If the same, then the vehicle support system 106 determines all of the versions have been received.

If additional versions are available, the vehicle support system 106 returns to operation 304 to retrieve the next software file for the next version. In some aspects, versions for the vehicle software for some of the modules 112 may be completed, while others are not. In such instance, the vehicle support system 106 continues to retrieve the software files for vehicle software that are not completely retrieved.

If all versions are received, the vehicle support system 106 generates the vehicle software plan based on the iterative and simulation process, at operation 308. In a non-limiting example, to generate the vehicle software plan, the vehicle support system 106 determines which vehicle modules 112 are updated, identifies part numbers for updated vehicle software, and provides download sequence of retrieved software vehicles for the vehicle modules 112. The vehicle support system 106 may also estimate the software update time for updating the vehicle software in the vehicle modules 112.

At operation 310, the vehicle support system 106 creates and transmits a software update message, which includes information indicative of the vehicle software plan to the vehicle service system 104. In some aspects, the software update message includes the software update time.

At operation 312, the vehicle support system 106 determines if the vehicle software plan is accepted or declined based on a message from the vehicle service system 104.

If declined, the vehicle support system 106 cancels the software update, at operation 314. For example, the vehicle support system 106 delete the vehicle software plan.

If approved, the vehicle support system 106, at operation 316, transmits a software update package including a software file for updating the vehicle software employed by the vehicle modules 112 to the vehicle system 100. Here, the vehicle support system 106 communicates directly with the vehicle system 100 for over the air software update.

At operation 318, the vehicle support system 106 determines if the software file(s) from successfully downloaded. For example, the vehicle support system 106 may receive a notification from the vehicle system 100 and/or from the vehicle service system 104 when the software file(s) provided is installed in the vehicle system 100.

If the software file(s) is not downloaded, the vehicle support system 106 waits. On the other hand, if the software file was downloaded, the vehicle support system 106 determines if the software update is completed. That is, the vehicle support system 106 determines if each of the software files provided in the vehicle software plan has been transmitted and downloaded.

If the software update is not complete, the vehicle support system 106 packages and transmits the next software file based on the vehicle software plan, at operation 320. Accordingly, the vehicle support system 106 sequentially and iteratively provides the software files for updating the vehicle software.

If the vehicle software update is complete, the vehicle support system 106 transmits a notification indicating completion of the vehicle software update to the vehicle service system 104, at operation 322. In some aspects, the vehicle support system 106 may further update the vehicle record associated with the vehicle 102 to memorialize the software update of the vehicle system 100.

In some aspects, the vehicle system 100 routinely updates the vehicle support system 106 on the software update being performed (e.g., provided a status after each vehicle software download being completed). If an error occurs during the update, the vehicle support system 106 may notify the vehicle service system 104 and wait further instructions from the system 104.

The routines 200 and 300 are just one example of the vehicle service system 104 and the vehicle support system 106 of the present disclosure. The routines 200 and 300 may be varied in various suitable ways based on the present disclosure. For example, the routines 200 and/or 300 may be interrupted by a cancellation command provided by the technician via the computing device 126 at any time or by the vehicle system 100.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, components (e.g., the communication system 110, vehicle modules 112, the communication module 122, the vehicle examination module 124 having the software update control 128, the communication module 130, the vehicle record module 132, the software update emulation module 134, and the software package module 136), may be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory device is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a universal serial bus (USB) drive, a compact disc (CD), a digital versatile disk (DVD), or a Blu-ray Disc).

The apparatuses and methods described in this application (e.g., routines 200 and 300, the communication system 110, vehicle modules 112, the communication module 122, the vehicle examination module 124 having the software update control 128, the communication module 130, the vehicle record module 132, the software update emulation module 134, and the software package module 136) may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system comprising:
a processor; and
a non-transitory computer readable medium comprising programming instructions that when executed by the processor, cause the processor to:
generate a vehicle software plan to update a vehicle software for a vehicle system from an installed version to a desired version, the vehicle software plan including any intervening software versions between the installed version and the desired version;
execute a vehicle software update to transmit, via a wireless communication link, one or more software packages to the vehicle system with the vehicle system being in a service mode in accordance with the vehicle software plan in response to the vehicle software plan being accepted; and
update the vehicle system from the service mode to a non-service mode in response to the vehicle software being updated to the desired version.

2. The system of claim 1, further comprising a software datastore storing a plurality of versions of the vehicle software, as software files for the vehicle software.

3. The system of claim 2, wherein to generate the vehicle software plan, the programming instructions that when executed by the processor, will cause the processor to:
iteratively and sequentially retrieve one or more relevant software files from the software datastore starting with the software file having a version immediately after the installed version and ending with the software file having the desired version;
for each retrieval, simulate a software update using the software file; and
identify one or more vehicle computing modules of the vehicle system that are updated in response to retrieving and simulating all the software files for the vehicle software, the vehicle software plan including information related to the software files for updating the vehicle software from the install version to the desired version for the vehicle computing modules and a download order of the software files.

4. The system of claim 1, wherein the programming instructions that when executed by the processor, will cause the processor to estimate a software update time that provides an estimate time for the vehicle software to be updated to the desired version based on the vehicle software plan.

5. The system of claim 1, wherein the programming instructions that when executed by the processor, cause the processor to:
transmit a software update message including information indicative of the vehicle software plan, the software update message including identification of one or more vehicle computing modules to receive the software update; and
receive at least one of an acceptance of the vehicle software plan or a deactivation of the vehicle software plan.

6. The system of claim 1, wherein the programming instructions that when executed by the processor, will cause the processor to cancel the vehicle software update in response to receiving a notification that the vehicle system is in the non-service mode.

7. The system of claim 1, wherein the programming instructions that when executed by the processor, will cause the processor to set the vehicle system to the service mode to inactivate selected control features of the vehicle system prior to the vehicle system receiving the vehicle software plan.

8. The system of claim 1, wherein the vehicle software includes a plurality of vehicle software for a plurality of vehicle control modules of the vehicle system, and the vehicle software plan defines an update of each vehicle software from the installed version to the desired version for the plurality of vehicle control modules of the vehicle system.

9. A non-transitory computer-readable medium comprising instructions for updating vehicle software in a vehicle system that, when executed by one or more processors perform operations including to:
generate a vehicle software plan to update a vehicle software for a vehicle system from an installed version to a desired version, the vehicle software plan including any intervening software versions between the installed version and the desired version;
execute a vehicle software update to transmit, via a wireless communication link, one or more software packages to the vehicle system with the vehicle system being in a service mode in accordance with the vehicle software plan in response to the vehicle software plan being accepted; and
updating the vehicle system from the service mode to a non-service mode in response to the vehicle software being updated to the desired version.

10. The non-transitory computer-readable medium of claim 9, wherein to generate the vehicle software plan, the instructions that, when executed by the one or more processors, perform operations:
iteratively and sequentially retrieve one or more relevant software files from a software datastore starting with the software file having a version immediately after the installed version and ending with the software file having the desired version, wherein the software datastore stores a plurality of versions of the vehicle software, as software files for the vehicle software;
for each retrieval, simulate a software update using the software file; and
identify one or more vehicle computing modules of the vehicle system that are updated in response to retrieving and simulating all the software files for the vehicle software, the vehicle software plan including information related to the software files for updating the vehicle software from the install version to the desired version for the vehicle computing modules and a download order of the software files.

11. The non-transitory computer-readable medium of claim 9, further comprising instructions that, when executed by the one or more processors, perform operations including estimate a software update time that provides an estimate time for the vehicle software to be updated to the desired version based on the vehicle software plan.

12. The non-transitory computer-readable medium of claim 9, further comprising instructions that, when executed by the one or more processors, perform operations including:
transmit a software update message including information indicative of the vehicle software plan, the software update message including identification of one or more vehicle computing modules to receive the software update; and
receive at least one of an acceptance of the vehicle software plan or a deactivation of the vehicle software plan.

13. The non-transitory computer-readable medium of claim 9, further comprising instructions that, when executed by the one or more processors, perform operations including cancel the vehicle software update in response to receiving a notification that the vehicle system is in the non-service mode.

14. The non-transitory computer-readable medium of claim 9, further comprising instructions that, when executed by the one or more processors, perform operations including set the vehicle system to the service mode to inactivate selected control features of the vehicle system prior to the vehicle system receiving the vehicle software plan.

15. The non-transitory computer-readable medium of claim 9, wherein the vehicle software includes a plurality of vehicle software for a plurality of vehicle control modules of the vehicle system, and the vehicle software plan defines an update of each vehicle software from the installed version to the desired version for the plurality of vehicle control modules of the vehicle system.

16. A method, comprising:
generating a vehicle software plan to update a vehicle software for a vehicle system from an installed version to a desired version, the vehicle software plan including any intervening software versions between the installed version and the desired version;
executing a vehicle software update to transmit, via a wireless communication link, one or more software packages to the vehicle system with the vehicle system being in a service mode in accordance with the vehicle software plan in response to the vehicle software plan being accepted; and
updating the vehicle system from the service mode to a non-service mode in response to the vehicle software being updated to the desired version.

17. The method of claim 16, further comprises, to generate the vehicle software plan:
iteratively and sequentially retrieving one or more relevant software files from a software datastore starting with the software file having a version immediately after the installed version and ending with the software file having the desired version, wherein the software datastore storing a plurality of versions of the vehicle software, as software files for the vehicle software;
for each retrieval, simulating a software update using the software file; and
identifying one or more vehicle computing modules of the vehicle system that are updated in response to retrieving and simulating all the software files for the vehicle software, the vehicle software plan including information related to the software files for updating the vehicle software from the install version to the desired version for the vehicle computing modules and a download order of the software files.

18. The method of claim 16, further comprising estimating a software update time that provides an estimate time for the vehicle software to be updated to the desired version based on the vehicle software plan.

19. The method of claim 16, further comprising
transmitting a software update message including information indicative of the vehicle software plan, the software update message including identification of one or more vehicle computing modules to receive the software update; and
receiving one of an acceptance of the vehicle software plan or a deactivation of the vehicle software plan.

20. The method of claim 16, further comprising setting the vehicle system to the service mode to inactivate selected control features of the vehicle system prior to the vehicle system receiving the vehicle software plan.
